(19) United States
(12) Patent Application Publication
(10) Pub. No.: US 2016/0323189 A1
(43) Pub. Date: Nov. 3, 2016

(54) METHOD FOR CONTROLLING QOS BY HANDLING TRAFFIC DEPENDING ON SERVICE

(71) Applicant: KT CORPORATION, Seongnam-si, (KR)

(72) Inventors: Tae Jin AHN, Daejeon (KR); Hyoung Soo KIM, Daejeon (KR); Se Hui LEE, Daejeon (KR); Kyung Ah HAN, Daejeon (KR)

(73) Assignee: KT Corporation, Seongnam-si (KR)

(21) Appl. No.: 15/032,707

(22) PCT Filed: Oct. 28, 2014
(86) PCT No.: PCT/KR2014/010169

§ 371 Date: Apr. 28, 2016

(30) Foreign Application Priority Data
Oct. 28, 2013 (KR) 10-2013-0128231
Oct. 28, 2014 (KR) 10-2014-0147076

(51) Int. Cl. H04L 12/851; H04L 12/863

(52) U.S. Cl. CPC H04L 47/24; H04L 47/6215

(57) ABSTRACT

A method for controlling QoS by handling traffic for each service in a software defined network environment is disclosed. The method of a controller controlling QoS comprises the steps of: determining a queue configuration change that includes performing one or more of adding, deleting and changing one or more queues configured to an output port of a network apparatus; and performing the configuration change by transmitting to the network apparatus a queue status change message including information about the determined queue configuration change. As a result, various services can be processed differently according to their traffic characteristics, thereby providing sufficient quality for each service and efficiently using network resources.

### TECHNICAL FIELD

The present disclosure relates to a quality of service (QoS) control method, and more particularly to a method far controlling QoS by processing traffics according to respective services in a software defined networking (SDN) environment.

### BACKGROUND ART

Currently, standardization on technologies for efficiently operating a communication system by separating a traffic forwarding function and a control function of a switch apparatus is going on in an Open Networking Foundation (ONF), an Internet Engineering Task Force (IETF), a European Telecommunications Standards Institute (ETSI) ISG Network Function Virtualization (NFV), and an International Telecommunications Union Telecommunication (ITU-T).

Software-defined networking (SDN) means a user-oriented network in which a user has control authority regardless of a basic network device such as a router or a switch, etc. and a separate software controller controls a flow of traffic.

OpenFlow is one variety of SDN technology and defines an interface connecting a hardware such as a router and a controller operating in a network operating system (OS), and is a. protocol for separating a control plane for controlling how to transmit a data packet through a network from a physical network and interacting with a data plane for data transmission.

On the other hand, in the internet, various services such as voice, video, data, wired communications, wireless communications, etc. are being integrated into a single network. Accordingly, techniques for efficiently utilizing network resources while guaranteeing qualities of the services according to their individual characteristics are becoming important.

For this, various QoS control methods for processing traffics differently according to characteristics of services to which the traffics belong are being developed and used by conventional switch apparatuses. However, since current OpenFlow standard specification defines only basic QoS control methods, there is a problem that the QoS of traffics for such the services having various characteristics cannot be controlled efficiently

### DISCLOSURE

### Technical Problem

The purpose of the present invention for resolving the above-described problem is to provide a QoS control method in a SDN environment.

Another purpose of the present invention for resolving the above-described problem is to provide a QoS control method which can process traffics differently according to characteristics of services to which the traffics belong.

Yet another purpose of the present invention for resolving the above-described problem is to provide a method for adding or deleting a queue for processing traffics according to services, and a QoS control method for processing traffics according to queue statistics and type of network to which the traffics belong.

### Technical Solution

In order to achieve the above-described purpose of the present invention, a method for controlling QoS, performed by a controller, according to an aspect of the present invention, may comprise determining a queue configuration change for performing at least one of adding, deleting and modifying at least one queue configured in an output port of a network apparatus; and performing the queue configuration change by transmitting to the network apparatus a queue status change message including information about the determined queue configuration change.

Here, the queue configuration change may be determined based on a service requirement or a change of QoS policy.

Here, the method may further comprise receiving queue property information for the at least one queue configured in the output port of the network apparatus; generating a flow entry which maps a service to the at least one queue based on the queue property information; and controlling the network apparatus to process a traffic depending on the service through the generated flow entry.

Here, in the receiving the queue property information, a queue status message including the queue property information may be received from the network apparatus.

Here, in the generating the flow entry, the at least one queue may be classified into a priority queue and at least one weighted round robin (WRR) queue, and services are mapped to the at least one queue based on priorities of the services.

Here, in the generating the flow entry, a traffic having a highest priority may be mapped to the priority queue, and traffics having next priorities may be mapped to the at least one WRR queue.

Here, in the generating the flow entry, the traffics having next priorities are sequentially allocated to a bandwidth remaining after processing the traffic having the highest priority according to weight values applied to the at least one WRR queue.

Here, in the generating the flow entry, a traffic allocated to at least one important server may be mapped to different WRR queues.

Here, the controlling the network apparatus may further comprise transmitting a Dow table modification message including the generated flow entry to the network apparatus; updating a flow table of the network apparatus by using the flow table modification message; and controlling the network apparatus to process traffics for respective services based on the updated flow table.

In order to achieve the above-described purpose of the present invention, a method for controlling QoS, performed by a controller, according to another aspect of the present invention, may comprise receiving a queue configuration information message including information about at least one queue supported by an output port of a network apparatus from the network apparatus; mapping services to the at least one queue based on the queue configuration information message and a QoS policy; and transmitting a queue status change message to the network apparatus so that the at least one queue is configured based on mapping relations between the services and the at least one queue.

Here, the mapping services to the at least one queue may further comprise configuring the at least one queue as a priority queue and at least one weighted round robin (WRR) queue; and mapping a service to each of the at least one queue based on a priority of the service.

Here, in the mapping a service to each of the at least one queue based on a priority of the service, a traffic for a service having a highest priority may be mapped to the priority queue, and traffics for services having next priorities may be sequentially mapped to the at least one WRR queue.

Here, in the mapping a service to each of the at least one queue based on a priority of the service, the traffics having next priorities may be sequentially allocated to a bandwidth remaining after processing the traffic having the highest priority according to weight values applied to the at least one WRR queue.

Here, the queue status change message may include a command for adding or deleting a queue in the output port of the network apparatus.

Here, the method may further comprise receiving information on loss packets from the network apparatus, and calculating a packet loss rate based on the information on loss packets; and changing a weight value applied to each of the at least one WRR queue based on the packet loss rate.

Here, in the changing a weight value applied to each of the at least one WRR queue, a command for changing the weight value may be transmitted to the network apparatus as included in the queue status message.

Here, the method may further comprise receiving a queue status message including queue property information for the at least one queue configured based on the queue status change message; generating a flow entry in which the service is mapped to the at least one queue based on the queue property information; and controlling the network apparatus to process traffics for respective services according to the generated flow entry.

In order to achieve the above-described purpose of the present invention, a method for controlling QoS, performed by a network apparatus, according to yet another aspect of the present invention, may comprise transmitting to a controller a queue configuration information message including information on a queue which can be supported by an output port of the network apparatus; receiving a queue status change message generated based on the queue configuration information message and a QoS policy from the controller; and configuring at least one queue in the output port according to the queue status change message.

Here, the queue status change message may include information which the controller generates by mapping services to the at least one queue based on the queue configuration information message and the QoS policy.

Here, the queue status change message may include information which the controller generates by mapping networks to the at least one queue according to the queue configuration information message and priorities of types of network based on the QoS policy.

Here, in the configuring at least one queue in the output port, a traffic for a service having a highest priority may be mapped to the priority queue, and traffics for services having next priorities may be sequentially mapped to the at least one WRR queue.

Here, in the configuring at least one queue in the output port, the traffics having next priorities may be sequentially allocated to a bandwidth remaining after processing the traffic having the highest priority according to weight values applied to the at least one WRR queue.

### Advantageous Effects

The above-described QoS control method for processing traffics depending on services, according to an exemplary embodiment of the present invention, can process various services differently according to their traffic characteristics, thereby providing sufficient quality for each service and efficiently using network resources.

Also, by using the method, a controller can correctly identify statuses of queues configured in a switch, thereby giving appropriate QoS control commands to the switch.

### DESCRIPTION OF DRAWINGS

FIG. 1 is a block diagram to explain a controller and a network apparatus performing a QoS control method for processing traffics depending on respective services according to an exemplary embodiment of the present invention.

FIG. 2 is a conceptual view to explain a priority queue and weighted round robin (WRR) queues according to an exemplary embodiment of the present invention.

FIG. 3 is a sequence chart to explain a QoS control method mapping queues to respective services according to an exemplary embodiment of the present invention.

FIG. 4 is an exemplary view to explain a queue status message according to an exemplary embodiment of the present invention.

FIG. 5 is a sequence chart to explain a method for controlling QoS by changing statuses of queues according to an exemplary embodiment of present invention.

FIG. 6 is a sequence chart to explain a procedure for adding a queue according to an exemplary embodiment of the present invention.

FIG. 7 is a sequence chart to explain a procedure for deleting a queue according to an exemplary embodiment of the present invention.

FIG. 8 is a sequence chart to explain a procedure for change a property of a queue based on a packet loss rate according to an exemplary embodiment of the present invention.

FIG. 9 is a sequence chart to explain a procedure for mapping traffics allocated to a specific server to different queues according to an exemplary embodiment of the present invention.

FIG. 10 is a sequence chart to explain a method for controlling QoS by mapping queues to types of network according to an exemplary embodiment of the present invention.

FIG. 11 is a conceptual view to explain a case in which queues are mapped to types of network according to exemplary embodiment of the present invention.

### BEST MODE

While the invention is susceptible to various modifications and alternative forms, specific embodiments thereof are shown by way of examples in the drawings and will herein be described in detail. It should be understood, however, that there is no intent to limit the invention to the particular forms disclosed, but on the contrary, the invention is meant to cover all modifications, equivalents, and alternatives falling within the spirit and scope of the invention. Like numbers refer to like elements in the accompanying drawings.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a controller used in the inventive concept may be a unified software-defined networking (SDN) controller, and mean a function entity controlling relevant components (for example, a switch, a router, etc.) for controlling a flow of traffic.

Further, the controller may not be limited by physical implementation shape or position, etc. For example, the controller may mean a controller function entity defined in open networking foundation (ONF), Internet engineering task force (IETF), a European telecommunication standards institute (ETSI), and/or international telecommunication union-telecommunication (ITU-T), etc.

A network apparatus used in the inventive concept may mean a function entity of actually forwarding, switching, or routing traffic (or a packet) such as a switch or a router. Accordingly, the network apparatus in the inventive concept may be referred to as the switch or the router. For example, the network device may mean the switch, the router, a switching element, a routing element, a forwarding element etc. defined in the ONF, IETF, ETSI, and/or ITU-T, etc.

In the exemplary embodiments of the present invention which will be explained below, examples, in which parameters and/or message types (e.g. flow table entry) defined by the ONF are used in operation procedures for controlling QoS in an OpenFlow switch, will be explained. However, the inventive concept of the present invention is not limited to the content defined by the ONF. Various parameters for a switch and a controller can be used in procedures for exchanging QoS control command between the controller and the switch, and messages used for the operation procedures for controlling QoS are also not limited to specific exemplary messages which will be explained later.

Hereinafter, preferred exemplary embodiments according to the present invention will be explained in detail by referring to accompanying figures.

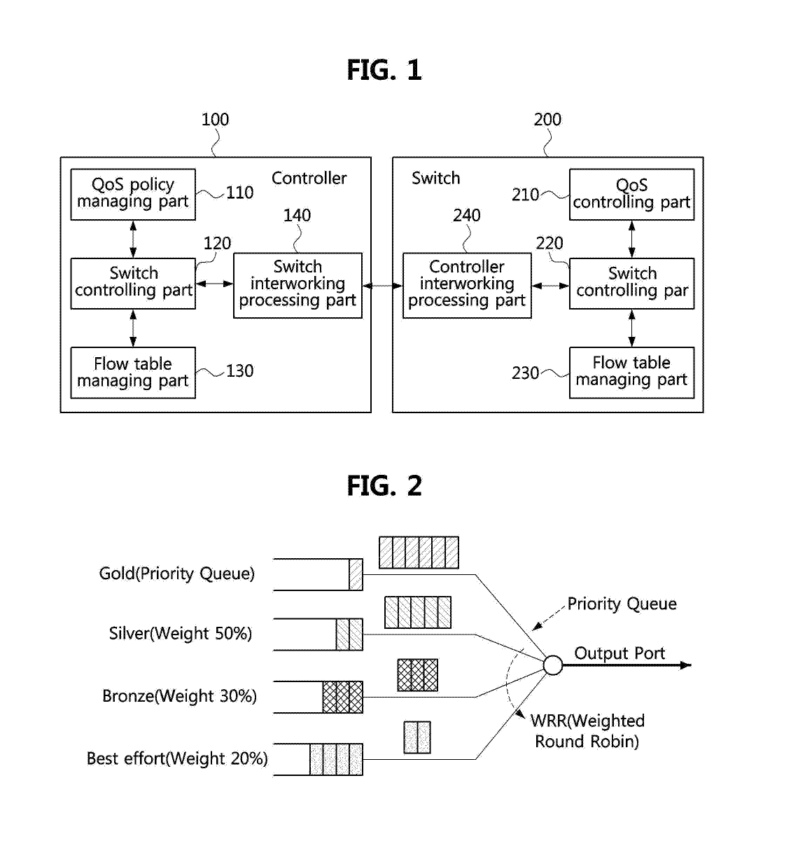

FIG. 1 is a block diagram to explain a controller and a network apparatus performing a QoS control method for processing traffics depending on respective services according to an exemplary embodiment of the present invention.

Referring to FIG. 1, a QoS control method for processing traffics depending on respective services, according to an exemplary embodiment of the present invention, may be performed through interworking of a controller 100 and a network apparatus 200 (e.g. a switch apparatus which also can be referred to as ‘switch’).

First, the controller 100 according to an exemplary embodiment of the present invention may comprise a QoS policy managing part 110, a switch controlling part 120, a flow table managing part 130, and a switch interworking processing part 140.

The QoS policy managing part 110 may manage QoS policies for network domains managed by the controller 100.

The switch controlling part 120 may control the switch 200 communicating with the controller 100 through the switch interworking processing part 140. For example, the switch controlling part 120 may generate a control command for adding, changing, or modifying flow entries based on a QoS policy managed by the QoS policy managing part 110, and control the switch 200 by using the control command.

The flow table managing part 130 may store and manage flow tables and parameters for synchronizing the flow tables.

The switch interworking processing part 140 may process a protocol for communications between the switch 200 and the controller 100.

Also, the switch 200 according to an exemplary embodiment of the present invention may comprise a QoS controlling part 210, a switch controlling part 220, a flow table managing part 230, and a controller interworking processing part 240.

The QoS controlling part 210 may perform a QoS control for a packet forwarded to an output port.

The switch controlling part 220 may perform controls for the switch 200 such as configuration of properties of queues in an output port. Also, the switch controlling part 220 may receive a control command from the controller 100, and perform operations according to the control command.

The flow table managing part 230 may manage flow tables transferred from the controller 100. That is, the flow table managing part 230 may store and manage flow tables for the switch and parameters for synchronizing the flow tables.

The controller interworking processing part 240 may process a protocol for communications between the controller 100 and the switch 200.

FIG. 2 is a conceptual view to explain a priority queue and weighted round robin (WRR) queues according to an exemplary embodiment of the present invention.

Referring to FIG. 2, at least one queue may be configured in an output port of a network apparatus.

For example, a case in which four queues are configured in the output port of the network apparatus will be explained in detail as follows.

In the case that four queues are configured in the output port of the network apparatus, a queue may be used as a priority queue, and three queues may be used as WRR queues.

For example, priorities of service traffics may be classified into ‘Gold’, ‘Silver’, ‘Bronze’ and ‘Best Effort (BE)’ according to their characteristics.

The traffic of the Gold service may be assigned to the priority queue and processed with the highest priority. That is, a packet located in the priority queue may be processed always before other packets located in other WRR queues.

The traffic of the Silver service may have a priority next to that of the Gold traffic. However, all the traffics of the Silver service may be not always processed before the traffics of the Bronze service or the BE service. The Silver service traffics may be processed according to a weight allocated to the Silver service, and then the Bronze service traffics may be processed.

The Bronze service traffics may be processed according to a weight allocated to the Bronze service, and then the BE service traffics may be processed.

For example, the Silver service may use 50% of a bandwidth remaining after use of the Gold service, the Bronze service may use 30% of the bandwidth remaining after use of the Gold service, and the BE service may use 20% of the bandwidth remaining after use of the Gold service. Thus, the Silver service traffic may be processed with a priority higher than that of the Bronze service, and the Bronze service traffic may be processed with a priority higher than that of the BE service.

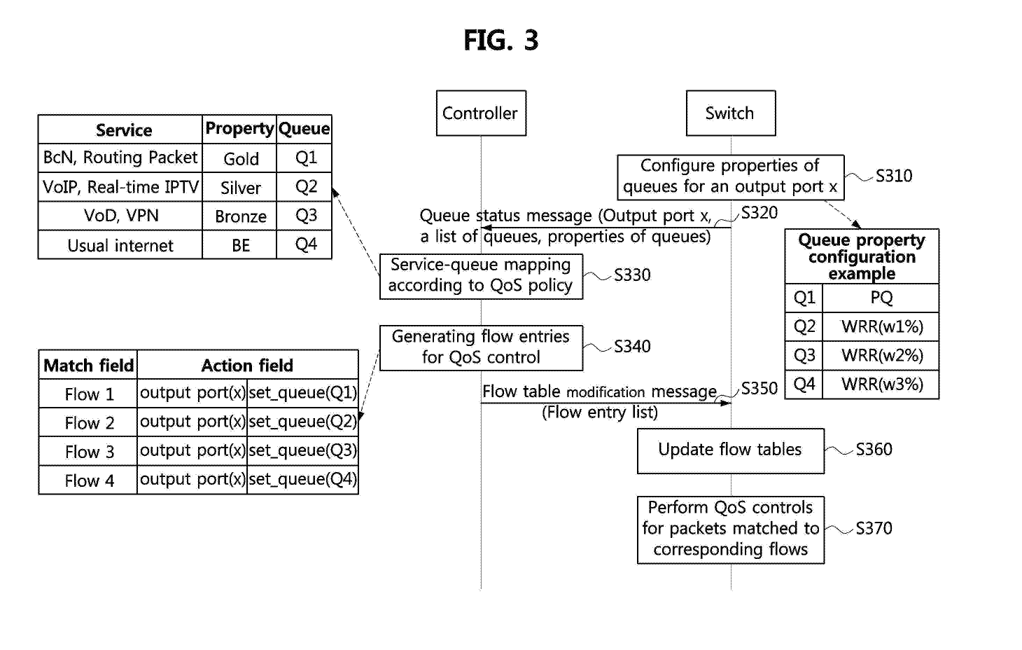

FIG. 3 is a sequence chart to explain a QoS control method mapping queues to respective services according to an exemplary embodiment of the present invention.

Referring to FIG. 3, the switch may configure properties of queues for an output port x by using a command line interface (CLI) or a configuration protocol.

More specifically, the switch may configure four queues for the output port x, a single queue Q1 as a priority queue, and remaining three queues Q2, Q3, and 04 as WRR queues. However, although a case in which the switch configures four queues for the output port x is explained, the number of queues configured for the output port x may vary according to features or performances provided by the switch. That is, the number of queues configured as WRR queues may be more than three.

For the three queues Q2, Q3, and Q4 configured as WRR queues, weights w1 for Q2, w2 for Q3, and w3 for Q4 may be set.

For example, the highest weight value may be set for Q2, a medium weight value may be set for Q3, and the lowest weight value may be set for Q4.

The switch may newly configure a queue property for the output port x, or, if a parameter value of the configured queue property is changed, immediately notify it to the controller through a queue status message (S320).

The queue status message may include queue property information such as information on the output port x status of which has changed, information on a list of configured queues, and information on properties of queues included in the list. Here, the information on properties of queues may include information on whether each queue is the priority queue or the WRR queue, and information on a weight assigned to each queue which is the WRR queue.

Upon receiving the queue status message from the switch, the controller may identify properties of respective queues from the queue property information included in the queue status message. Thus, the controller may configure a service-queue mapping table for defining mapping relations between services and queues according to characteristics of services (S330).

The mapping relations between services and queues may be determined by establishing a QoS policy in consideration of importance of each service and sensitivity of each service to delay or loss of packets according to a network operation policy.

For example, very important packets used for a broadband convergence network (BcN) service or routing protocols may be classified as the Gold service traffic, and they may be allocated to Q1. Also, important packets for a voice over internet protocol (VoIP) or an IPTV service may be classified as the Silver service traffic, and they may be allocated to Q2.

Also, packets belonging to a video on demand (VoD) service or a virtual private network (VPN) service may be classified as the Bronze service traffic, and they may be allocated to Q3. Also, packets belonging to usual internet services may be classified as the BE service traffic, and they may be allocated to Q4.

After the controller configures the service-queue mapping table, the controller may configure or generate at least one flow entry so that a flow for the service can be forwarded to the corresponding queue (S340).

The flow entry may comprise at least one match field for discriminating flows and at least one action field for indicating actions to be performed for the corresponding flow packets.

For example, the controller may generate at least one flow entry for making a first flow corresponding to the BCN service or routing protocol be forwarded to Q1, making a second flow corresponding to the VoIP or IPTV service be forwarded to Q2, making a third flow corresponding to the VoD or VPN service be forwarded to Q3, and making a fourth flow corresponding to the usual internet service be forwarded to Q4.

After generating the at least one flow entry, the controller may transmit the generated flow entries to the switch by including the flow entry in a flow table modification message (S350).

The switch may receive the flow table modification message from the controller, and use the generated flow entries (a list of generated flow entries) included in the flow table modification message to update flow tables of the switch (S360).

Accordingly, the switch may perform QoS controls according to queue properties by forwarding inputted packets to the corresponding queues according to actions indicated by action fields matched to the corresponding flow. In other words, the switch may perform QoS controls by allocating flows to different queues (e.g. the priority queue or WRR queues) according to services to which the flows belong (S370).

FIG, 4 is an exemplary view to explain a queue status message according to an exemplary embodiment of the present invention.

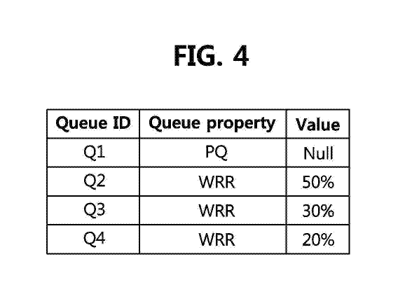

Referring to FIG. 4, an example of a queue status message which the switch transmits to the controller is explained as follows.

Four queues are allocated to the output port x. Among them, the Q1 may be configured as a priority queue (denoted as ‘PQ’), and its weight value may be configured as NULL.

The Q2 may be configured as a WRR queue, and its weight value may be configured as 50%. Also, the Q3 may be configured as a WRR queue, and its weight value may be configured as 30%. Also, the Q4 may be configured as a WRR queue, and its weight value may be configured as 20%.

In addition, the weight values assigned to respective WRR queues may be determined by considering priorities and traffic amounts for respective services allocated to respective queues. Also, the weight values may be changed according to information collected periodically when operating the queues.

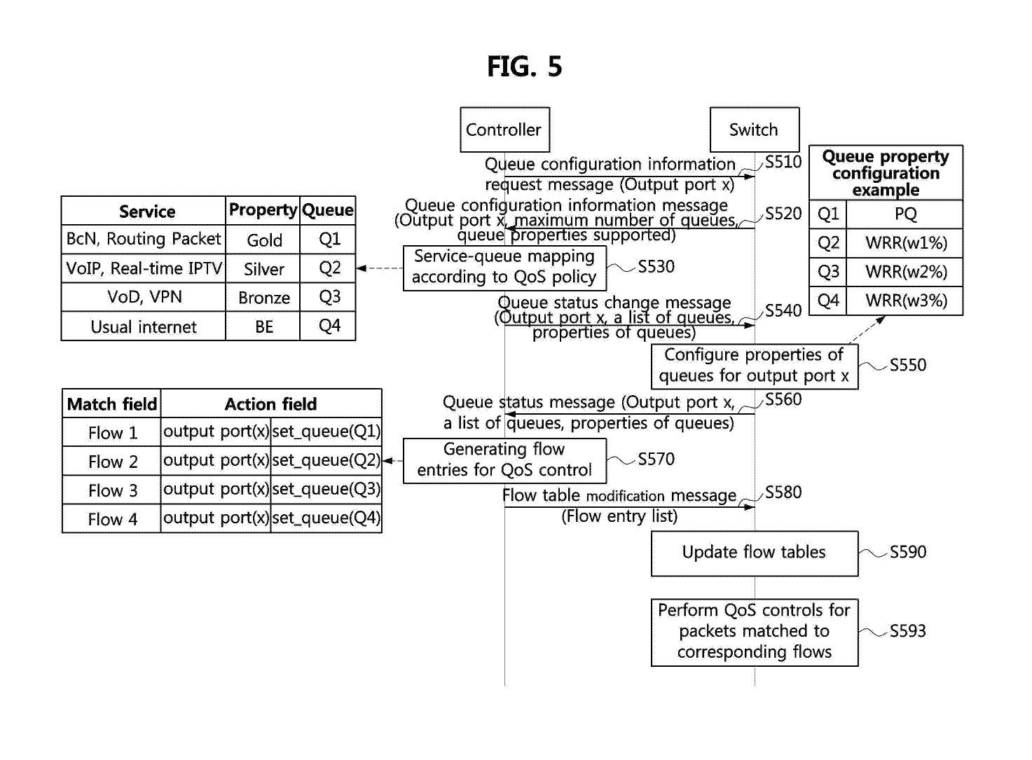

FIG. 5 is a sequence chart to explain a method for controlling QoS by changing statuses of queues according to an exemplary embodiment of present invention.

Referring to FIG. 5, the controller may control QoS by transmitting a queue status change message to the switch.

Specifically, in order to change a queue status of an output port x of the switch (e.g, add/modify/delete a queue in the output port x), the controller may be required to know queue configuration information such as the maximum number of queues which can be configured in the output port x or queue properties which can be supported by the output port x.

In order to identify the queue configuration information of the switch, the controller may transmit a queue configuration information request message to the switch (S510). In this case, if an output port parameter of the message is configured as x, the switch may transmit a queue configuration information message for the output port x to the controller (S520). Here, the queue configuration information message may include information such as information on the maximum number of queues which can be configured in the output port x or information on queue properties which can be supported by the output port x.

Also, if the output port parameter of the message is configured as ‘ANY’ instead of ‘x’, the switch may transmit queue configuration information for all output ports which the switch has.

Specifically, in response to the queue configuration information request message, the switch may transmit to the controller a queue configuration information message including queue configuration information such as information on the maximum number of queues which can be configured in the output port x or information on queue properties which can be supported by the output port x.

Similarly, if the output port parameter of the queue configuration information request message is configured as ‘ANY’, the switch may compose configuration information such as the maximum numbers of queues and supportable queue properties for all output ports in a list form, and transmit the composed list to the controller.

Some switches may have the same configuration information such as the maximum numbers of queues and supportable queue properties for all output ports. For these switches, the output port parameter may be configured as ‘ANY’, and configuration information such as the maximum number of queues and supportable queue properties may be transmitted once.

After receiving the queue configuration information message, the controller may determine mapping between services and queues according to a QoS policy (S530).

The switch may configure four queues for the output port x. Among them, Q1 may be configured as a priority queue, and three queues Q2, Q3, and 04 may be configured as WRR queues.

For example, very important packets used for a broadband convergence network (BcN) service or routing protocols may be classified as the Gold service traffic, and they may be allocated to Q1. Also, important packets for a voice over internet protocol (VolP) or an IPTV service may be classified as the Silver service traffic, and they may be allocated to Q2 having the highest weight value.

Also, packets belonging to a video on demand (VoD) service or a virtual private network (VPN) service may be classified as the Bronze service traffic, and they may be allocated to Q3 having a medium weight value. Also, packets belonging to usual internet services may be classified as the BE service traffic, and they may be allocated to Q4 having the lowest weight value.

After performing the service-queue mapping according to the QoS policy, the controller may transmit a queue status change message to the switch in order to applying the service-queue mapping to the switch (S540).

The queue status change message may include an output port x as an output port parameter, a command, a queue list, and property information for respective queues. Here, the command may be a command for adding, deleting, or modifying a queue. Also, the queue property information may be understood by referring to the table depicted in FIG. 4.

The switch may receive the queue status change message from the controller, and configure properties of queues in the output port x (S550) by using the queue status change message.

For example, for the output port x, the switch may configure Q1 as a priority queue, and three queues Q2, Q3, and Q4 as WRR queues. Also, weight values for Q2, Q3, and Q4 may be respectively configured as w1%, w2%, and w3%.

After configuring the queue property of the output port x, the switch may transmit a queue status message to the controller (S560). Here, the queue status message may include an output port x, a list of queues, properties of queues, etc.

After receiving the queue status message from the switch, the controller may generate at least one flow entry for controlling QoS (S570), and transmit a flow entry change message including the at least one flow entry to the switch (S580).

Accordingly, the switch having received the flow table modification message may update its flow table (S590), and perform QoS controls for actual packets (S593).

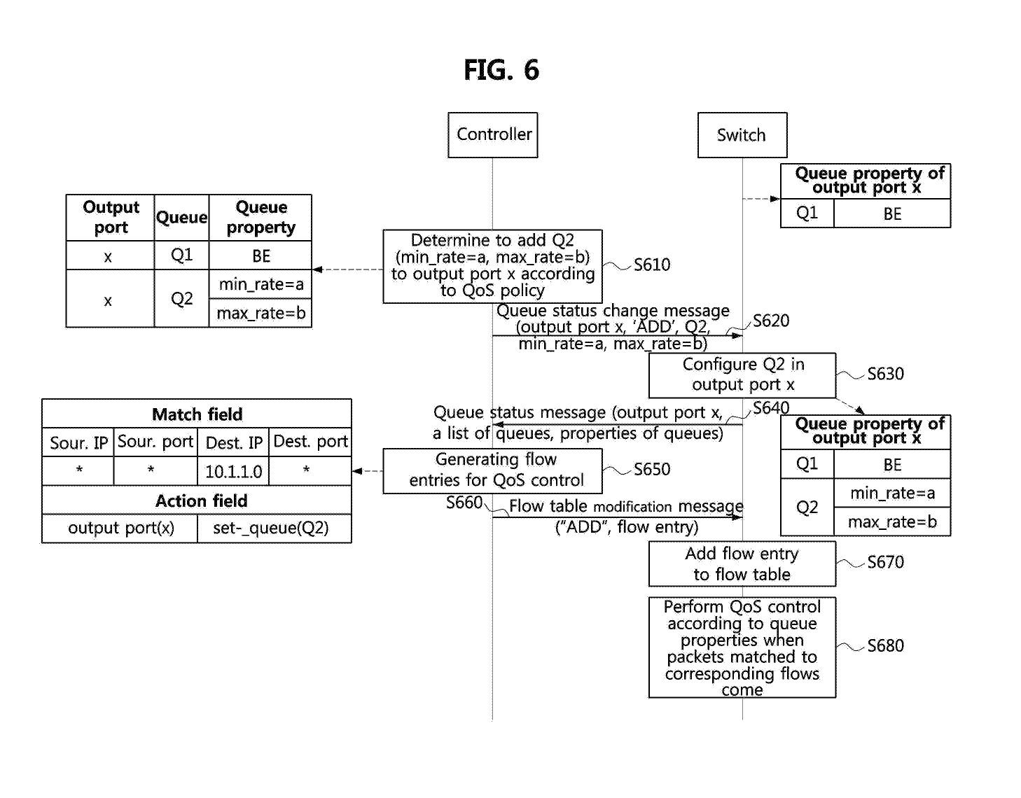

FIG. 6 is a sequence chart to explain a procedure for adding a queue according to an exemplary embodiment of the present invention.

Referring to FIG. 6, the controller may add a queue to an output port by transmitting an ‘ADD’ command to the switch.

A case, in which only Q1 is configured in the output port x of the switch and a property of Q1 is configured as ‘BE’, will be explained as an example.

In this case, all packets arriving at the output port x may be processed identically through Q1.

The controller may add a queue having anew queue property to the switch according to a request of service system or a change of QoS policy.

For example, when a service requirement of guaranteeing a minimum bandwidth for traffics having a specific destination is given from the service system or the QoS policy, only the single queue Q1 configured in the switch cannot satisfy the service requirement. Thus, addition of a queue having a new property is required.

Referring to FIG. 6, the controller may determine to add a new queue Q2 to the output port x according to the QoS policy, and allocate a bandwidth (min_rate=a, max_rate=b) to Q2 according to the property of Q2 (S610).

That is, the Q2 may guarantee the minimum bandwidth a bps (or, kbps or Mbps) for its traffics and restrict its maximum bandwidth to b bps (or, kbps or Mbps) for its traffics. For example, when the output port x has a bandwidth of 1 Gbps, the mini mum bandwidth for Q2 may be a ×10 Mbps, and the maximum bandwidth for Q2 may be b×10 Mbps.

The controller may transmit a queue status change message to the switch (S620). Here, the queue status change message may include parameters such as the output port x, a command (‘ADD’) instructing to add anew queue, an identifier of the queue (i.e. Q2) to be added, property of the queue to be added, etc. Thus, by using the queue status change message including the command instructing to add a new queue, the Q2 may be added to the output port x. Also, as the property of Q2, the minimum bandwidth of Q2 may be configured to be a % of the maximum bandwidth of the output port x, and the maximum bandwidth of Q2 may be configured to be b % of the maximum bandwidth of the output port x.

More specifically, after receiving the queue status change message from the controller, the switch may configure Q2 in the output port x (S630). For example, two queues Q1 and Q2 may be configured in the output port x.

After configuring the new queue Q2 in the output port x, the switch may transmit a queue status message to the controller (S640). Here, the queue status message may include parameters such as the output port x, a list of configured queues Q1 and Q2, properties of the queues, etc.

After receiving the queue status message from the switch, the controller may generate at least one flow entry for QoS control by referring to the queue status message (S650).

For example, the controller may generate at least one flow entry making all packets whose destination addresses (e.g. destination IP addresses) are 10.1.1.0 be forwarded to Q2 of the output port x.

After generating the at least flow entry, the controller may transmit a flow table modification message including the generated flow entry to the switch (S660). Here, the flow table modification message may include parameters such as the at least one flow entry and a command instructing to add the at least one flow entry to the flow table of the switch.

Upon receiving the flow table modification message, the switch may add the new flow entry included in the flow table modification message to its flow table (S670). Accordingly, the switch may perform QoS control according to the property of Q2 by forwarding all packets whose destination addresses are 10.1,1.0 to Q2 of the output port x (S680).

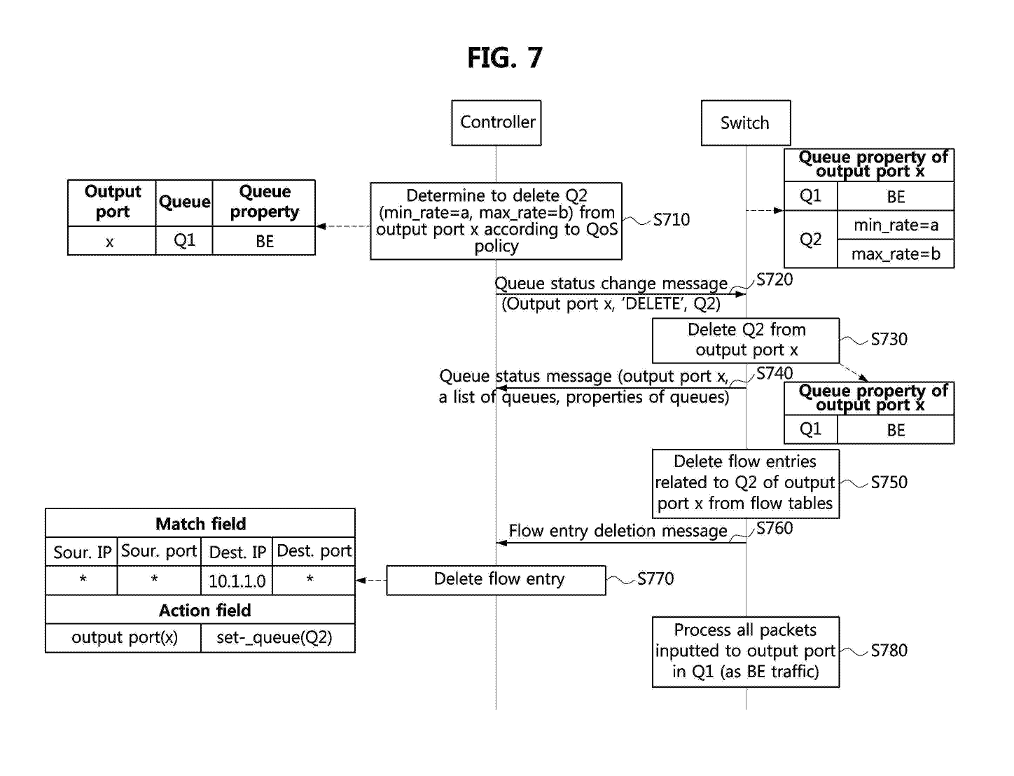

FIG. 7 is a sequence chart to explain a procedure for deleting a queue according to an exemplary embodiment of the present invention.

Referring to FIG. 7, the controller may delete a queue in an output queue of the switch by transmitting a ‘DELETE’ command to the switch.

A case, in which two queues Q1 and Q2 are configured in the output port x of the switch, the property of Q1 is configured as BE, the minimum bandwidth of Q2 is configured as a % of the maximum bandwidth of the output port x (i.e. nin_rate=a), and the maximum bandwidth of Q2 is configured as b % of the maximum bandwidth of the output port x (i.e. max_rate=b), will be explained.

The controller may determine to delete a queue configured in the switch according to a request of a service system or a change of a QoS policy (S710). For example, in a case that a predetermined bandwidth is guaranteed for traffics to be forwarded to a specific server, if the service stops a service, it becomes unnecessary to guarantee the predetermined bandwidth for the server. Also, in a case that a predetermined bandwidth is guaranteed for traffics to be forwarded to a specific customer, if the customer cancels or changes a service, it becomes unnecessary to guarantee the predetermined bandwidth for the customer. In these cases, it is required to delete Q2 configured in the output port x of the switch.

When the controller determines to delete Q2 in the output port x of the switch, the controller may transmit a queue status change message to the switch (S720). Here, the queue status change message may include parameters such as the output port x, a command instructing delete a queue, and an identifier of the queue to be deleted.

Upon receiving the queue status change message from the controller, the switch may delete Q2 in the output port x (S730). Accordingly, Q2 among two Queues Q1 and Q2 may be deleted, and only Q1 may remain in the output port x.

After deleting Q2, the switch may transmit a queue status message to the controller (S740). Here, the queue status message may include parameters such as the output port x, a list of queues (i.e. Q1), and a property of queues (i.e. Q1).

Also, the switch may delete flow entries related to Q2 of the output port x from its flow tables (S750), and transmit a flow entry deletion message to the controller (S760).

Upon receiving the flow entry deletion message from the switch, the controller may delete corresponding flow entries (S770).

For example, the switch may delete flow entries for making all packets whose destination addresses (e.g. destination IP addresses) are 10.1.1.0 be forwarded to Q2 of the output port x. Accordingly, all packets transferred to the output port x of the switch may be forwarded to Q1, and processed as BE traffics (S780).

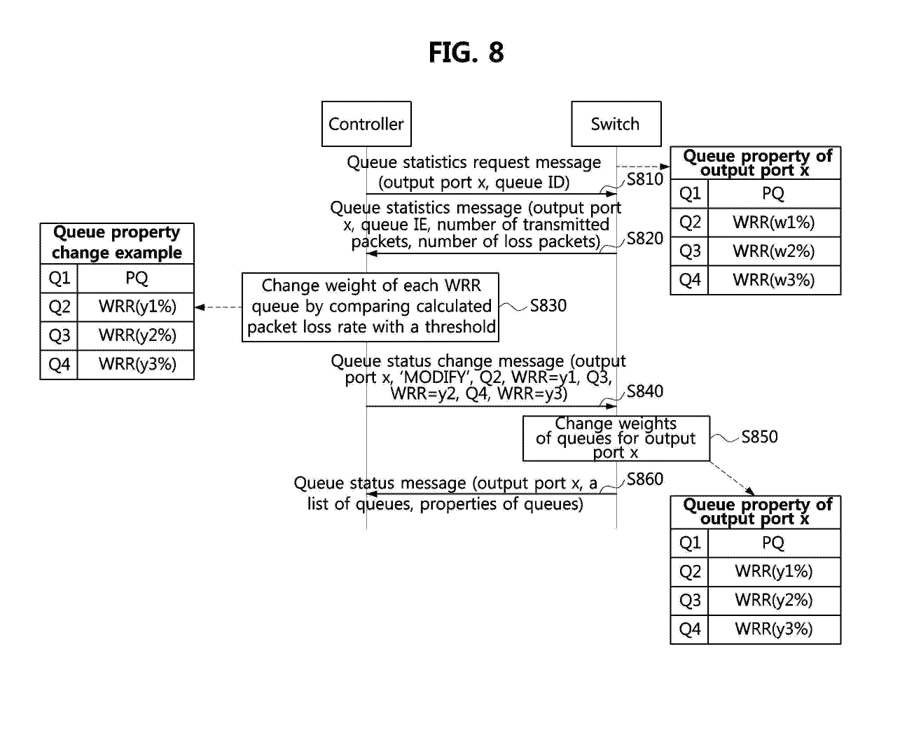

FIG. 8 is a sequence chart to explain a procedure for change a property of a queue based on a packet loss rate according to an exemplary embodiment of the present invention.

Referring to FIG. 8, according to a change of QoS policy or an analysis on overall traffics, the controller may change a property of a previously configured queue.

For example, when at least one WRR queue is configured in the output port x, weight values for the at least one WRR queue may be changed flexibly according to traffic situations.

More specifically, the controller may request traffic statistics data for queues configured in a switch by periodically transmitting a queue statistics request message to the switch (S810). Here, the queue statistics request message may include parameters such as the corresponding output port and identifiers of queues whose statistics are requested.

The switch may transmit a queue statistics message including traffic statistics data for the queues according to the queue statistics request message to the controller (S820). Here, the queue statistics message may include parameters such as the output port x, an identifier (ID) of a queue, information on the number of packets transmitted through the queue, and information on the number of loss packets of the queue.

Upon receiving the queue statistics message, the controller may calculate a packet loss rate for the queue (S830). Here, the packet loss rate may be calculated as (the number of loss packets/(the number of transmitted packets+the number of loss packets)).

The controller may compare the calculated packet loss rate of each queue with a threshold preconfigured for each queue, and change a weight value of each WRR queue based on the comparison result (S830).

For example, when traffic of the Silver service becomes more than expected and thus a service quality of the Silver service degrades, a weight value of Q2 allocated to the Silver service may be increased so that more traffic can be processed through Q2.

When a property of a queue changes, the controller may transmit a queue status change message including the changed property of the queue to the switch (S840). Here, the queue status change message may include parameters such as the output port x, a command instructing to modify the property of the queue, an identifier of the queue whose property is to be modified, and information on the property to be modified.

According to the queue status change message, the switch may change weight values of respective queues (S850), and transmit a queue status message including the result to the controller (S860). For example, the switch may change the weight values w1%, w2%, and w3% for the WRR queues Q2, Q3, and Q4 to y1%, y2%, and y3%.

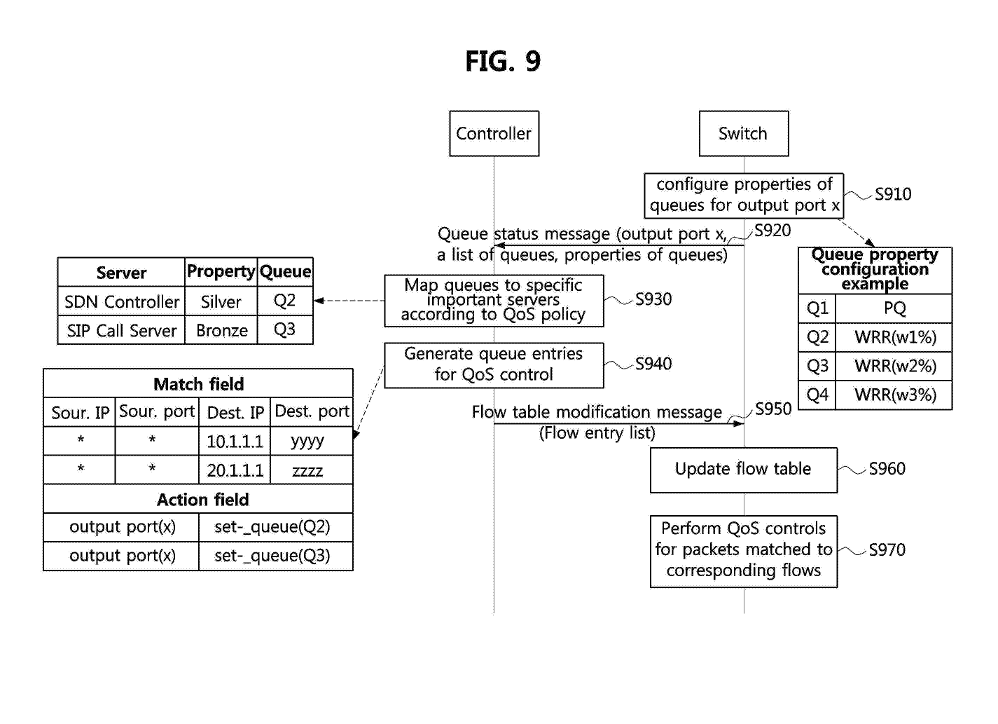

FIG. 9 is a sequence chart to explain a procedure for mapping traffics allocated to a specific server to different queues according to an exemplary embodiment of the present invention.

Referring to FIG. 9, the controller may map traffics for specific servers to queues so that the traffics for the specific servers can be processed discriminatorily as compared to usual data traffics.

First, the switch may configure queues and properties of the queues in an output port (S910). The controller may identify information on the queues configured in the switch by receiving a queue status message from the switch (S920).

According to a QoS policy, the controller may configure a queue mapping table for processing traffics for important servers discriminatorily as compared to usual data traffics (S930).

For example, the controller may map traffics for a software defined networking (SDN) controller to Q2 in order to process the traffics as the Silver service, and map traffics for a session initiation protocol (SIP) call server to Q3 in order to process the traffics as the Bronze service.

After configuring the queue mapping table for the important servers, the controller may generate flow entries so that actual flows can be forwarded to corresponding queues S940).

For example, a case, in which the SDN controller uses 10.1.1.1 as its IP address, and uses ‘yyyy’ as a port for a TCP connection with a switch, and the SIP call server uses 20.1.1.1 as its IP address, and uses ‘zzzz’ as a port for a TCP connection with a terminal, will be explained.

The flow entry generated by the controller may comprise at least one match field for discriminating flows and at least one action field for indicating actions to be performed for the corresponding flow packets.

For example, since only destination IP addresses and ports are necessary for the flows of traffics for the SDN controller, source IP addresses and ports for them may be indicated as ‘*’ which means ‘Any’. Similarly, since only destination IP addresses and ports are necessary for the flows of traffics for the SIP call server, source IP addresses and ports for them may also be indicated as ‘*’.

Also, the action field may include actions for making the traffic flows toward the SND controller be forwarded to Q2, and making the traffic flows toward the SIP call server be forwarded to Q3.

After generating the flow entry, the controller may transmit a flow table modification message including the generated flow entry to the switch (S950).

Upon receiving the flow table modification message from the controller, the switch may use the flow entry included in the received flow table modification message to update a flow table in the switch (S960).

Accordingly, when a packet toward the SDN controller comes, the switch may process the packet as the Silver traffic of the WRR type by forwarding the packet to Q2 of the output port x. Also, when a packet toward the SIP call server comes, the switch may process the packet as the Bronze traffic of the WRR type by forwarding the packet to Q3 of the output port x. Through this, the QoS control according to properties of corresponding queues may be performed by the switch (S970).

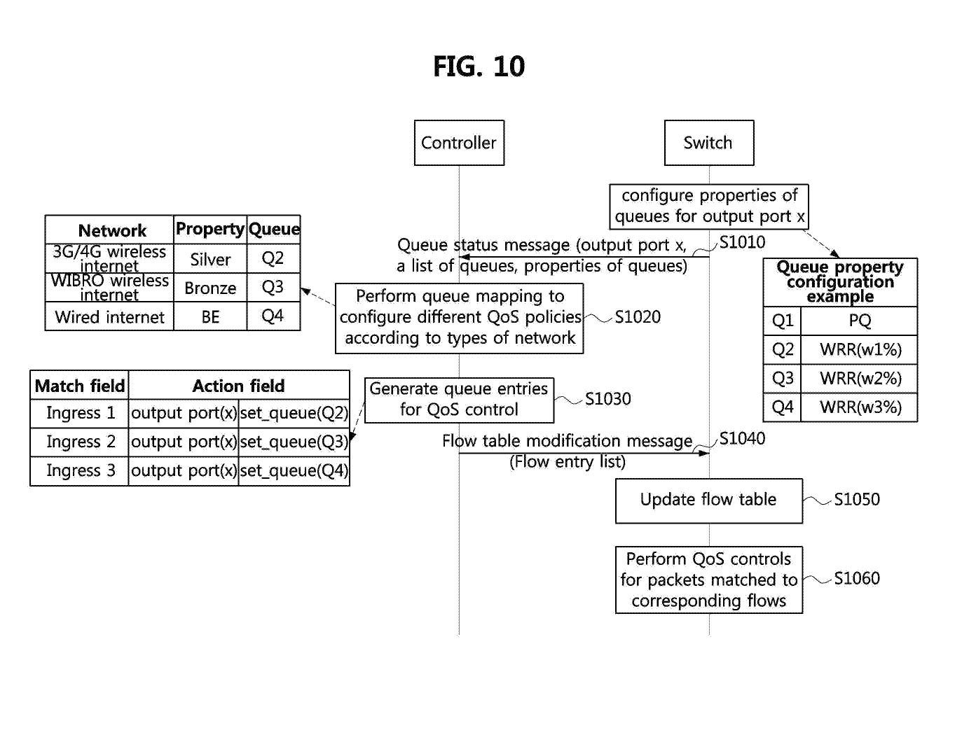

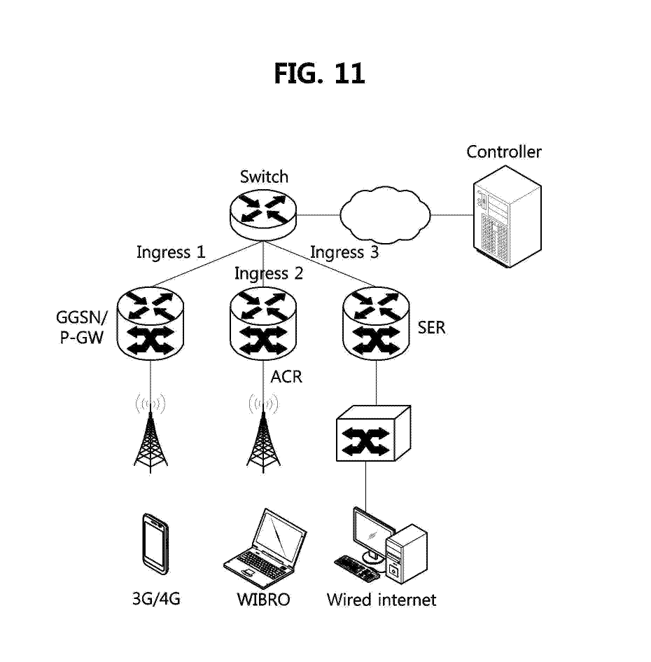

FIG. 10 is a sequence chart to explain a method for controlling QoS by mapping queues to types of network according to an exemplary embodiment of the present invention, and FIG. 11 is a conceptual view to explain a case in which queues are mapped to types of network according to exemplary embodiment of the present invention.

Referring to FIG. 10, the controller may perform QoS control according to types of network by interworking with the switch.

First, the switch may configure queues and properties of the queues in an output port (S1010). The controller may identify information on the queues configured in the switch by receiving a queue status message from the switch (S1020).

The controller may configure a queue mapping table which can configure different QoS policies for respective queues according to types of network by referring to the queue status message (S1030).

For example, the controller may map wireless internet traffic coming from a 3G or 4G wireless access network to Q2 so that the wireless internet traffic can be processed as the Silver service, map wireless internet traffic coming from a WiBro (i.e. WiMax) wireless access network to Q3 so that the wireless internet traffic can be processed as the Bronze service, and map wired internet traffic coming from a wired internet access network to Q4 so that the wired internet traffic can be processed as the BE service.

Usually, the highest cost is required for a 3G/4G wireless network to process a predetermined amount of traffic data, the next higher cost is required for a WiMax wireless network to process the same, and the lowest cost is required for a wired internet to process the same. Thus, a QoS policy can be determined so that the 3G/4G wireless internet traffic can be handled as the Silver service, the WiBro wireless internet traffic can be handled as the Bronze service, and the wired internet traffic can be handled as the BE service. Also, the controller may control QoS based on the QoS policy according to types of network.

After configuring the queue mapping table for differentiating traffics according to types of network, the controller may generate a flow entry for mapping actual flows to corresponding queues (S1040).

Referring to FIG. 10 and FIG. 11, the 3G/4G wireless internet traffic may be configured to arrive through an Ingress 1, the WiMax wireless internet traffic may be configured to arrive through an Ingress 2, and the wired internet traffic may be configured to arrive through an Ingress 3.

For example, the controller may generate flow entries in which an action field for forwarding flows arriving through Ingress 1 of a match field to Q2 of the output port x is configured, an action field for forwarding flows arriving through Ingress 2 of a match field to Q3 of the output port x is configured, and an action field for forwarding flows arriving through Ingress 3 of a match filed to Q4 of the output port x is configured.

After generating the flow entries, the controller may transmit a flow table modification message including the generated flow entries to the switch (S1050).

The switch may receive the flow table modification message from the controller, and update its flow tables by using the flow entries included in the flow table modification message.

Thus, the switch may forward the 3G/4G wireless internet traffic inputted through the Ingress 1 to Q2 of the output port x thereby processing the 3G/4G wireless internet traffic as the Silver service, forward the WiMax wireless internet traffic inputted through the Ingress 2 to Q3 of the output port x thereby processing the WiMax wireless internet traffic as the Bronze service, and forward the wired internet traffic inputted through the Ingress 3 to Q4 of the output port x thereby processing the wired internet traffic as the BE service. Accordingly, the switch may perform QoS control according to types of network (S1060).

According to the above-described exemplary embodiments of the present invention, an OpenFlow switch can perform QoS control by processing traffics differently according to types of service.

Also, according to the above-described exemplary embodiments of the present invention, a WRR method can be applied to the OpenFlow switch so that various services can be processed differently according to characteristics of their traffics.

In addition, according to the above-described exemplary embodiments of the present invention, when statuses of queues in the switch change, the changes of the statues of queues can be immediately notified to the controller so that the controller can perform QoS control efficiently by changing properties of the queues according to management policies or traffic situation of network.

While the example embodiments of the present invention and their advantages have been described in detail, it should be understood that various changes, substitutions and alterations may be made herein without departing from the scope of the invention.

1. A method for controlling quality of service (QoS), performed by a controller, the method comprising:
determining a queue configuration change for performing at least one of adding, deleting and modifying at least one queue configured in an output port of a network apparatus; and
performing the queue configuration change by transmitting to the network apparatus a queue status change message including information about the determined queue configuration change.

2. The method according to claim 1, wherein the queue configuration change is determined based on a service requirement or a change of QoS policy.

3. The method according to claim 1, further comprising:
receiving queue property information for the at least one queue configured in the output port of the network apparatus;
generating a flow entry which maps a service to the at least one queue based on the queue property information; and
controlling the network apparatus to process a traffic depending on the service through the generated flow entry.

4. The according to claim 3, wherein, in the receiving the queue property information, a queue status message including the queue property information is received from the network apparatus.

5. The method according to claim 3, wherein, in the generating the flow entry, the at least one queue is classified into a priority queue and at least one weighted round robin (WRR) queue, and services are mapped to the at least one queue based on priorities of the services.

6. The method according to claim 5, wherein, in the generating the flow entry, a traffic having a highest priority is mapped to the priority queue, and traffics having next priorities are mapped to the at least one WRR queue.

7. The method according to claim 6, wherein, in the generating the flow entry, the traffics having next priorities are sequentially allocated to a bandwidth remaining after processing the traffic having the highest priority according to weight values applied to the at least one WRR queue.

8. The method according to claim 5, wherein, in the generating the flow entry, a traffic allocated to at least one important server is mapped to different WRR queues.

9. The method according to claim 3, wherein the controlling the network apparatus further comprises:
transmitting a flow table modification message including the generated flow entry to the network apparatus;
updating a flow table of the network apparatus by using the flow table modification message; and
controlling the network apparatus to process traffics for respective services based on the updated flow table.

10. A method for controlling quality of service (QoS), performe by a controller, the method comprising:
receiving a queue configuration information message including information about at least one queue supported by an output port of a network apparatus from the network apparatus;
mapping services to the at least one queue based on the queue configuration information message and a QoS policy; and
transmitting a queue status change message to the network apparatus so that the at least one queue is configured based on mapping relations between the services and the at least one queue.

11. The method according to claim 10, wherein the mapping services to the at least one queue comprises:
configuring the at least one queue as a priority queue and at least one weighted round robin (WRR) queue; and
mapping a service to each of the at least one queue based on a priority of the service.

12. The method according to claim 11, wherein, in the mapping a service to each of the at least one queue based on a priority of the service, a traffic for a service having a highest priority is mapped to the priority queue, and traffics for services having next priorities are sequentially mapped to the at least one WRR queue.

13. The method according to claim 12, wherein, in the mapping a service to each of the at least one queue based on a priority of the service, the traffics having next priorities are sequentially allocated to a bandwidth remaining after processing the traffic having the highest priority according to weight values applied to the at least one WRR queue.

14. The method according to claim 10, wherein the queue status change message includes a command for adding or deleting a queue in the output port of the network apparatus.

15. The method according to claim 11, further comprising:
receiving information on loss packets from the network apparatus, and calculating a packet loss rate based on the information on loss packets; and
changing a weight value applied to each of the at least one WRR queue based on the packet loss rate.

16. The method according to claim 15, wherein, in the changing a weight value applied to each of the at least one WRR queue, a command for changing the weight value is transmitted to the network apparatus as included in the queue status message.

17. The method according to claim 10, further comprising:
receiving a queue status message including queue property information for the at least one queue configured based on the queue status change message;
generating a flow entry in which the service is mapped to the at least one queue based on the queue property information; and
controlling the network apparatus to process traffics for respective services according to the generated flow entry.

18. A method for controlling quality of service (QoS), performed by a network apparatus, the method comprising:
transmitting to a controller a queue configuration information message including information on a queue which can be supported by an output port of the network apparatus;
receiving a queue status change message generated based on the queue configuration information message and a QoS policy from the controller; and
configuring at least one queue in the output port according to the queue status change message.

19. The method according to claim 18, wherein the queue status change message includes information which the controller generates by mapping services to the at least one queue based on the queue configuration information message and the QoS policy.

20. The method according to claim 18, wherein the queue status change message includes information which the controller generates by mapping networks to the at least one queue according to the queue configuration information message and priorities of types of network based on the QoS policy.

21. The method according to claim 18, wherein, in the configuring at least one queue in the output port, a traffic for a service having a highest priority is mapped to the priority queue, and traffics for services having next priorities are sequentially mapped to the at least one WRR queue.

22. The method according to claim 21, wherein, in the configuring at least one queue in the output port, the traffics having next priorities are sequentially allocated to a bandwidth remaining after processing the traffic having the highest priority according to weight values applied to the at least one WRR queue.
